(19) United States
(12) Patent Application Publication
(10) Pub. No.: US 2026/0241764 A1
(43) Pub. Date: Aug. 20, 2026

(54) CONTROL DEVICE

(71) Applicant: AISIN CORPORATION, Kariya, Aichi (JP)

(72) Inventor: Akihito YAMAMOTO, Kariya-shi, Aichi-ken (JP)

(73) Assignee: AISIN CORPORATION, Kariya, Aichi (JP)

(21) Appl. No.: 18/872,394

(22) PCT Filed: Jun. 21, 2023
(86) PCT No.: PCT/JP2023/022992

§ 371 Date: Dec. 6, 2024

(30) Foreign Application Priority Data
Aug. 26, 2022 (JP) 2022-135275

(51) Int. Cl. B60G 17/016; B60G 17/015

(52) U.S. Cl. CPC B60G 17/0164; B60G 17/0152; B60G 2400/102; B60G 2400/208

(57) ABSTRACT

A control device includes an acquisition unit that acquires acceleration of a vehicle body in a vertical direction of a vehicle, and an estimation unit that uses a neural network that has performed learning so as to estimate a relative speed of a wheel with respect to the vehicle body in the vertical direction of the vehicle based on an input of a numerical value obtained by multiplying the acceleration by a mass of the vehicle to estimate the relative speed corresponding to a numerical value obtained by multiplying the acceleration acquired by the acquisition unit by the mass with a same magnitude as or a different magnitude from a mass at a time of learning of the neural network, and the suspension device is controlled based on the relative speed estimated.

### CROSS REFERENCE TO RELATED APPLICATIONS

This application is a National Stage of International Application No. PCT/JP2023/022992 filed Jun. 21, 2023, claiming priority based on Japanese Patent Application No. 2022-135275 filed Aug. 26, 2022, the entire contents of which are incorporated in their entirety.

### TECHNICAL FIELD

Embodiments of the present disclosure relate to a control device.

### BACKGROUND ART

Conventionally, a technique is known in which a relative speed of a wheel with respect to a vehicle body in a vehicle vertical direction, a so-called stroke speed, is estimated by a physical quantity estimation device, and a damping force of a shock absorber in a suspension device is controlled on the basis of the estimated stroke speed.

### CITATION LIST

### Patent Literature

Patent Literature 1: JP 10-913 A

Patent Literature 2: JP 2016-117326 A

### SUMMARY OF THE DISCLOSURE

### Technical Problems

In a case where a physical quantity such as a stroke speed is estimated using a neural network, it takes time and effort because the neural network is created for each specification of a vehicle.

Therefore, one of the problems of the embodiments of the present disclosure is, for example, to reduce the time and effort required for creating a neural network even in a case where there are a plurality of specifications for a vehicle.

### Solutions to Problems

A control device according to an embodiment of the present disclosure is a control device that controls a suspension device interposed between a vehicle body of a vehicle and a wheel of the vehicle, the control device includes an acquisition unit that acquires acceleration of the vehicle body in a vertical direction of the vehicle, and an estimation unit that uses a neural network that has performed learning so as to estimate a relative speed of the wheel with respect to the vehicle body in the vertical direction of the vehicle based on an input of a numerical value obtained by multiplying the acceleration by a mass of the vehicle to estimate the relative speed corresponding to a numerical value obtained by multiplying the acceleration acquired by the acquisition unit by the mass with a same magnitude as or a different magnitude from a mass at a time of learning of the neural network, and the suspension device is controlled based on the relative speed estimated.

### Advantageous Effects of Various Aspects of the Disclosure

According to the control device of the embodiments of the present disclosure, for example, the neural network with the same content can be used for vehicles having a plurality of specifications with different masses. Therefore, even in a case where there are a plurality of vehicle specifications, it is possible to reduce the time and effort required for creating the neural network.

### BRIEF DESCRIPTION OF DRAWINGS

FIG. 1 is a schematic diagram illustrating a schematic configuration of an example of a vehicle according to a first embodiment.

FIG. 2 is a schematic diagram illustrating a schematic configuration of an example of a suspension device in the vehicle according to the first embodiment.

FIG. 3 is a functional block diagram of a control device of an example of the vehicle according to the first embodiment.

FIG. 4 is an explanatory diagram for explaining a physical quantity of the vehicle according to the first embodiment.

FIG. 5 is a diagram illustrating an example of a neural network to be examined.

FIG. 6 is a diagram illustrating an example of an estimation result of a stroke speed by the neural network to be examined, and is a diagram illustrating a case where the mass of the vehicle is a reference mass.

FIG. 7 is a diagram illustrating an example of the estimation result of the stroke speed by the neural network to be examined, and is a diagram illustrating a case where the mass of the vehicle is half of the reference.

FIG. 8 is a diagram illustrating an example of the estimation result of the stroke speed by the neural network to be examined, and is a diagram illustrating a case where the mass of the vehicle is 1.5 times the reference.

FIG. 9 is a diagram illustrating an example of an estimation result of a stroke speed by an equation of motion to be examined, and is a diagram illustrating a case where the mass of the vehicle is a reference mass.

FIG. 10 is a diagram illustrating an example of the estimation result of the stroke speed by the equation of motion to be examined, and is a diagram illustrating a case where the mass of the vehicle is half of the reference.

FIG. 11 is a diagram illustrating an example of the estimation result of the stroke speed by the equation of motion to be examined, and is a diagram illustrating a case where the mass of the vehicle is 1.5 times the reference.

FIG. 12 is a diagram for explaining a neural network to be examined.

FIG. 13 is a diagram illustrating a neural network according to the first embodiment.

FIG. 14 is a diagram illustrating an example of an estimation result of a stroke speed by the neural network according to the first embodiment, and is a diagram illustrating a case where the mass of the vehicle is a reference mass.

FIG. 15 is a diagram illustrating an example of the estimation result of the stroke speed by the neural network according to the first embodiment, and is a diagram illustrating a case where the mass of the vehicle is half of the reference.

FIG. 16 is a diagram illustrating an example of the estimation result of the stroke speed by the neural network according to the first embodiment, and is a diagram illustrating a case where the mass of the vehicle is 1.5 times the reference.

FIG. 17 is a diagram illustrating an example of an estimation result of a stroke speed by an equation of motion of a comparative example, and is a diagram illustrating a case where the mass of the vehicle is a reference mass.

FIG. 18 is a diagram illustrating an example of the estimation result of the stroke speed by the equation of motion of the comparative example, and is a diagram illustrating a case where the mass of the vehicle is half of the reference.

FIG. 19 is a diagram illustrating an example of the estimation result of the stroke speed by the equation of motion of the comparative example, and is a diagram illustrating a case where the mass of the vehicle is 1.5 times the reference.

FIG. 20 is a flowchart illustrating an example of a physical quantity estimation direction performed by a control device according to the first embodiment.

FIG. 21 is a diagram illustrating a neural network according to a second embodiment.

FIG. 22 is a diagram illustrating a neural network according to a third embodiment.

FIG. 23 is a diagram illustrating a neural network according to a fourth embodiment.

### DESCRIPTION OF EMBODIMENTS

Hereinafter, embodiments will be described in detail with reference to the drawings. Note that the present disclosure is not limited by the embodiments. Similar components are included in the following embodiments. The similar components are denoted by the same reference numerals, and redundant description will be omitted.

### First Embodiment

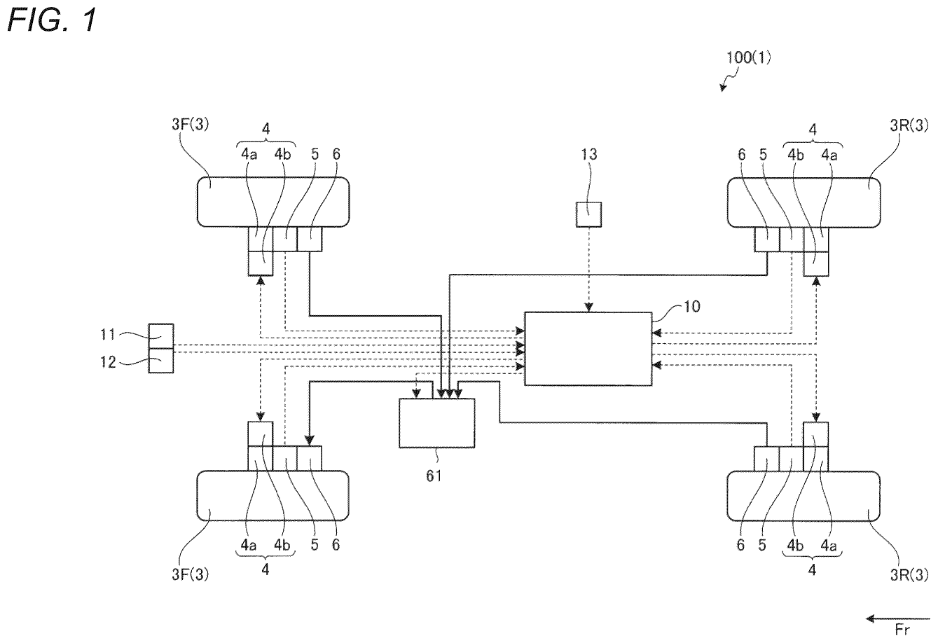

FIG. 1 is a schematic diagram illustrating a schematic configuration of an example of a vehicle 1 according to a first embodiment. In the present embodiment, the vehicle 1 may be, for example, an automobile (internal combustion engine automobile) using an internal combustion engine (engine, not illustrated) as a drive source, an automobile (electric vehicle, fuel cell vehicle, or the like) using an electric motor (motor, not illustrated) as a drive source, or an automobile (hybrid vehicle) using both of them as drive sources. In addition, the vehicle 1 can be equipped with various transmission devices, and can be equipped with various devices (systems, components, and the like) necessary for driving the internal combustion engine and the electric motor. Moreover, the type, number, layout, and the like of devices related to driving of wheels 3 in the vehicle 1 can be variously set. In the present embodiment, as an example, the vehicle 1 is a four-wheeled vehicle (four-wheeled automobile), and includes two left and right front wheels 3F and two left and right rear wheels 3R. Note that, in FIG. 1, the front side (direction Fr) in a vehicle front-rear direction is the left side. The vehicle 1 is an example of an object. Note that the object may be a moving body, a device, or the like other than the vehicle 1.

In the present embodiment, as an example, a vehicle control system 100 of the vehicle 1 includes a control device 10, a steering device 11, a steering angle sensor 12, a yaw rate sensor 13, a braking system 61, and the like. In addition, the vehicle control system 100 includes a suspension device 4, a rotation sensor 5, an acceleration sensor 6, and the like corresponding to each of the two front wheels 3F, and includes the suspension device 4, the rotation sensor 5, the acceleration sensor 6, and the like corresponding to each of the two rear wheels 3R. Note that, although the vehicle 1 includes basic components for the vehicle 1 in addition to those in FIG. 1, only the configuration related to the vehicle control system 100 and control related to the configuration will be described here. In addition, the two front wheels 3F and the two rear wheels 3R are collectively referred to as wheels 3. Furthermore, the relative speed of the wheel 3 of the vehicle 1 with respect to a vehicle body 2 of the vehicle 1 is also referred to as a stroke speed, a portion of the vehicle 1 on the vehicle body 2 side of the suspension device 4 is also referred to as a sprung portion, and a portion of the vehicle 1 on the wheel 3 side of the suspension device 4 is also referred to as an unsprung portion. In addition, unless otherwise specified in the following description, the relative speed is a relative speed of the wheel 3 with respect to the vehicle body 2 in the vertical direction of the vehicle 1.

The control device 10 receives signals, data, and the like from each unit of the vehicle control system 100, and executes control of each unit of the vehicle control system 100 and various computations. The control device 10 is also referred to as a state quantity estimation device, a vehicle state quantity estimation device, or a physical quantity estimation device. The control device 10 is configured as a computer, and includes an arithmetic processing unit (microcomputer, electronic control unit (ECU), or the like, which is not illustrated), a storage unit 10d (for example, read only memory (ROM), random access memory (RAM), flash memory, or the like, see FIG. 3), and the like. The arithmetic processing unit can read a program stored (installed) in the nonvolatile storage unit 10d (for example, ROM, flash memory, or the like), perform computation processing in accordance with the program, and function (operate) as each unit illustrated in FIG. 3. Furthermore, the storage unit 10d can store data (tables (data groups), functions, and the like) used in various computations related to control, calculation results (including values in the middle of computation), and the like. Moreover, the storage unit 10d stores a neural network 121. Details of the neural network 121 will be described later.

The steering device 11 includes, for example, a steering wheel, and steers (turns) the two front wheels 3F. The steering angle sensor 12 detects a steering angle (steering angle, steering angle, turning angle) of the front wheel 3F and outputs steering angle data indicating the detected steering angle.

The yaw rate sensor 13 detects a yaw rate of the vehicle 1 (vehicle body 2) and outputs yaw rate information indicating the detected yaw rate.

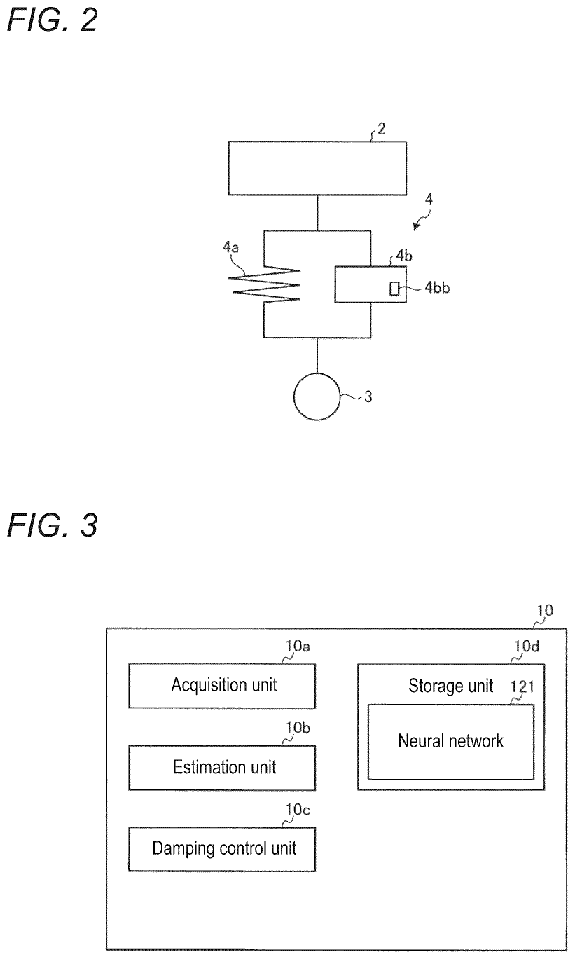

FIG. 2 is a schematic diagram illustrating a schematic configuration of an example of the suspension device 4 in the vehicle according to the first embodiment. As illustrated in FIG. 2, the suspension device 4 is interposed between the wheel 3 and the vehicle body 2, and suppresses transmission of vibration and impact from a road surface to the vehicle body. The suspension device 4 includes a coil spring 4a and a shock absorber 4b. The shock absorber 4b can electrically control (adjust) a damping force (damping characteristic). Specifically, the shock absorber 4b includes an actuator 4bb that operates on the basis of an input current. The actuator 4bb can change the opening of an orifice provided in a piston of the shock absorber 4b or change the opening between a valve body and a valve seat. As a result, the amount of lubricant flowing between two oil chambers partitioned by the piston in the shock absorber 4b is controlled to adjust the damping force of the shock absorber 4b. The suspension device 4 is provided on each of the four wheels 3 (two front wheels 3F and two rear wheels 3R), and the control device 10 can control the damping force of each of the four wheels 3. The control device 10 can control the four wheels 3 to have different damping forces. Specifically, in order to control the damping force (=damping coefficient×stroke speed) of the shock absorber 4b, the damping coefficient is controlled. More specifically, the damping coefficient is controlled by controlling the current flowing through the actuator 4bb of the shock absorber 4b.

The rotation sensor 5 can output a signal corresponding to the rotational speed (angular speed, rotation speed, rotation state) of each of the four wheels 3. The control device 10 can calculate the speed of the vehicle 1 from the detection result of the rotation sensor 5. Note that a rotation sensor (not illustrated) that detects rotation of a crankshaft, an axle, or the like may be provided separately from the rotation sensor 5 for the wheel 3, and the control device 10 may acquire the speed of the vehicle 1 from a detection result of the rotation sensor.

The acceleration sensor 6 is provided in the vehicle body 2 corresponding to each of the four wheels 3 and each of the suspension devices 4, and detects the acceleration of the vehicle body 2 in the vehicle 1. Specifically, each acceleration sensor 6 is provided at an acceleration detection target position located immediately above each wheel 3 (immediately above the wheel) in the vehicle body 2. That is, in the present embodiment, there are four acceleration detection target positions. In the present embodiment, as an example, the acceleration sensor 6 can acquire acceleration in the vertical direction of the vehicle 1, acceleration in the front-rear direction (longitudinal direction) of the vehicle 1, and acceleration in the width direction (vehicle width direction, lateral direction, left-right direction) of the vehicle 1.

Note that the configuration of the vehicle control system 100 described above is merely an example, and can be variously changed and implemented. As individual devices constituting the vehicle control system 100, known devices can be used. Furthermore, each configuration of the vehicle control system 100 can be shared with other configurations.

In the present embodiment, as an example, the control device 10 can function (operate) as an acquisition unit 10a, an estimation unit 10b, a damping control unit 10c, and the like illustrated in FIG. 3 by cooperation of hardware and software (program). That is, the program may include, as an example, modules corresponding to the individual blocks except for the storage unit 10d illustrated in FIG. 3.

The acquisition unit 10a acquires acceleration data indicating the acceleration of the vehicle 1 from each acceleration sensor 6. The acceleration of the vehicle 1 may be acceleration in any direction. In addition, the acceleration of the vehicle 1 may be acceleration in a plurality of directions. That is, the acceleration of the vehicle 1 may be one or more of the acceleration in the front-rear direction of the vehicle 1, the acceleration in the left-right direction of the vehicle 1, and the acceleration in the vertical direction of the vehicle 1. Furthermore, the acquisition unit 10a acquires a current value (current value data), which is a value of current input to the shock absorber 4b, from the damping control unit 10c.

As an example, predetermined data (hereinafter, also referred to as input data) acquired by the acquisition unit 10a is input to the estimation unit 10b. The estimation unit 10b estimates the stroke speed based on the input data using the neural network 121. The input data includes at least acceleration data. In addition to the acceleration data, the input data may include at least one of yaw rate data, current value data, steering angle data, or wheel speed data. Note that the input data is not limited to data described above.

Here, there may be a plurality of specifications (types and specifications) in one vehicle system of the vehicle 1. For example, the plurality of specifications include a gasoline/two-wheel drive specification, a hybrid/two-wheel drive specification, a gasoline/four-wheel drive specification, a hybrid/four-wheel drive specification, and the like. In the gasoline/two-wheel drive specification, the drive source is a gasoline engine and the drive wheels are two wheels. In the hybrid/two-wheel drive specification, the drive sources are a gasoline engine and an electric motor, and the drive wheels are two wheels. In the gasoline/four-wheel drive specification, the drive source is a gasoline engine and the drive wheels are four wheels. In the hybrid/four-wheel drive specification, the drive sources are a gasoline engine and an electric motor, and the drive wheels are four wheels. The vehicles 1 having such a plurality of specifications have different masses, for example. For this reason, in order to estimate the stroke speed of each vehicle 1, a neural network is conventionally created for each vehicle 1 even in one vehicle system. In order to create the neural network, it is necessary to perform learning by measuring input data and teacher data, and it takes time and effort to create a plurality of neural networks.

Therefore, the present inventor has examined a configuration (method) of capable of reducing the time and effort required for creating the neural network even in a case where there are a plurality of specifications for the vehicle 1. The contents examined by the inventor will be described below.

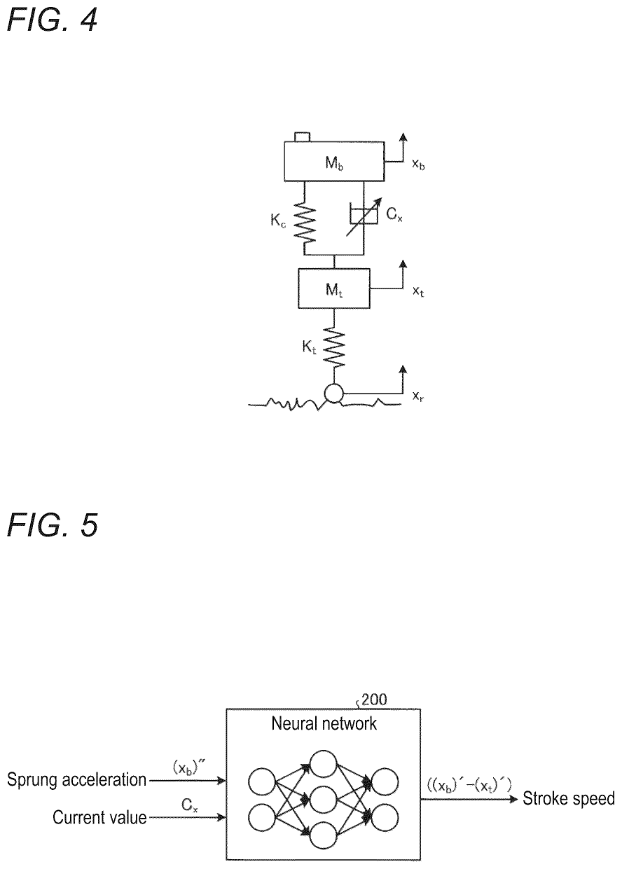

The inventor has compared a neural network with an equation of motion representing the motion of the vehicle 1. FIG. 4 is an explanatory diagram for explaining a physical quantity of the vehicle 1 according to the first embodiment. As illustrated in FIG. 4, it is assumed that the mass of the vehicle 1 is M_{b}, the sprung displacement amount, which is a displacement amount of the vehicle body 2 in the vertical direction, is x_{b}, the spring constant of the coil spring is K_{c}, the damping coefficient of the shock absorber 4b is Cₓ, the unsprung displacement amount, which is a displacement amount of the wheel 3 in the vertical direction, is xₜ, the spring constant of the tire of the wheel 3 is kₜ, and the displacement amount of the lower end portion of the tire is xᵣ. In this case, the equation of motion of the vehicle 1 is expressed by the following equation (1).

$${M}_{b} ( {x}_{b} ) ” = - {K}_{c} ( {x}_{b} - {x}_{t} ) - {C}_{x} ( ( {x}_{b} ) ’ - ( {x}_{t} ) ’ ) \qquad ( 1 )$$

Note that ′ and ″ in equation (1) represent a first derivative and a second derivative, respectively.

Therefore, the estimated stroke speed ((x_{b})′−(xₜ)′) is expressed by equation (2).

$$( ( {x}_{b} ) ’ - ( {x}_{t} ) ’ ) = - ( {M}_{b} ( {x}_{b} ) ” ) / {C}_{x} - ( {K}_{c} ( {x}_{b} - {x}_{t} ) ) / {C}_{x} \qquad ( 2 )$$

FIG. 5 is a diagram illustrating an example of a neural network 200 to be examined. As illustrated in FIG. 5, in the neural network 200 to be examined, the input data is the sprung acceleration and the current value of the shock absorber 4b, and the output data is the stroke speed.

The neural network 200 and expressions (1) and (2) are created with the reference mass of the vehicle 1.

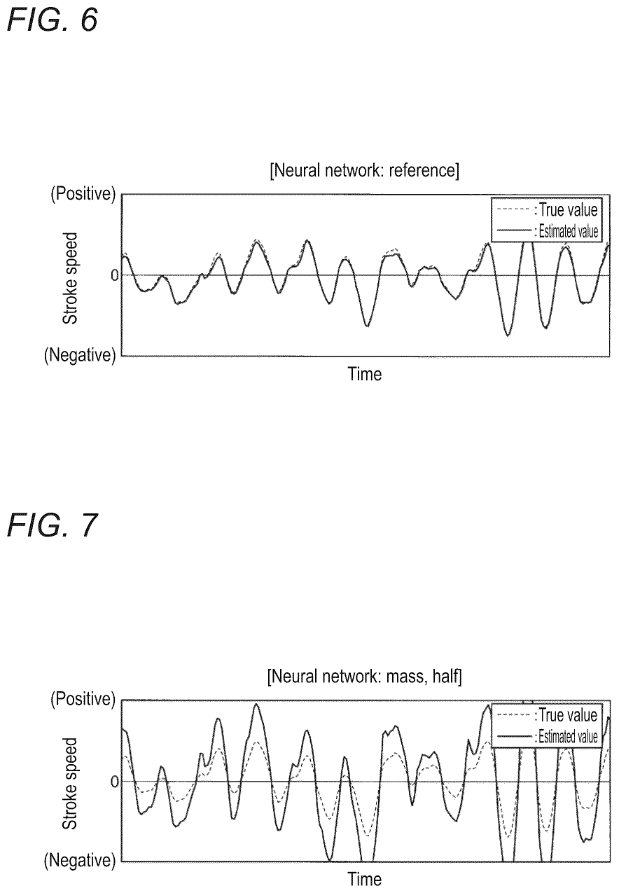

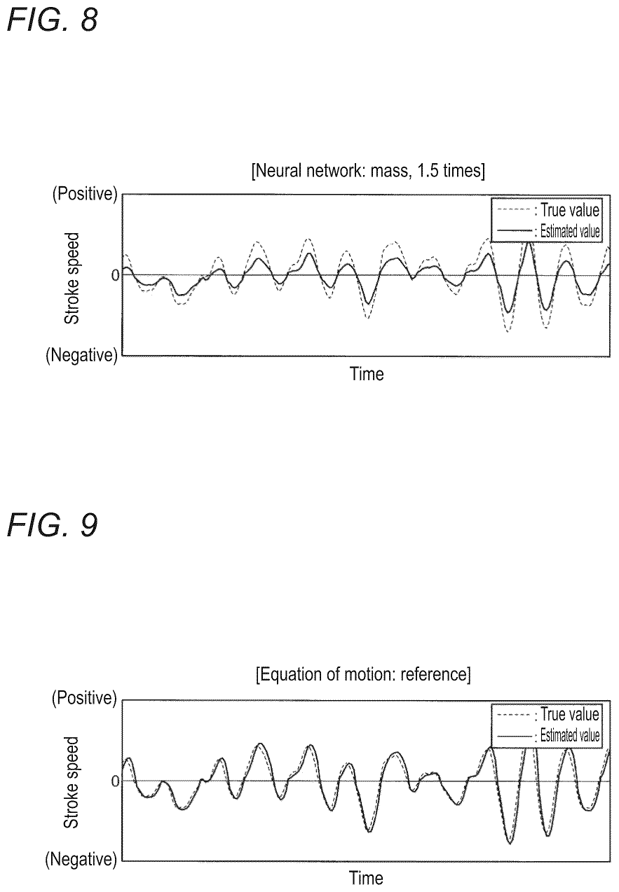

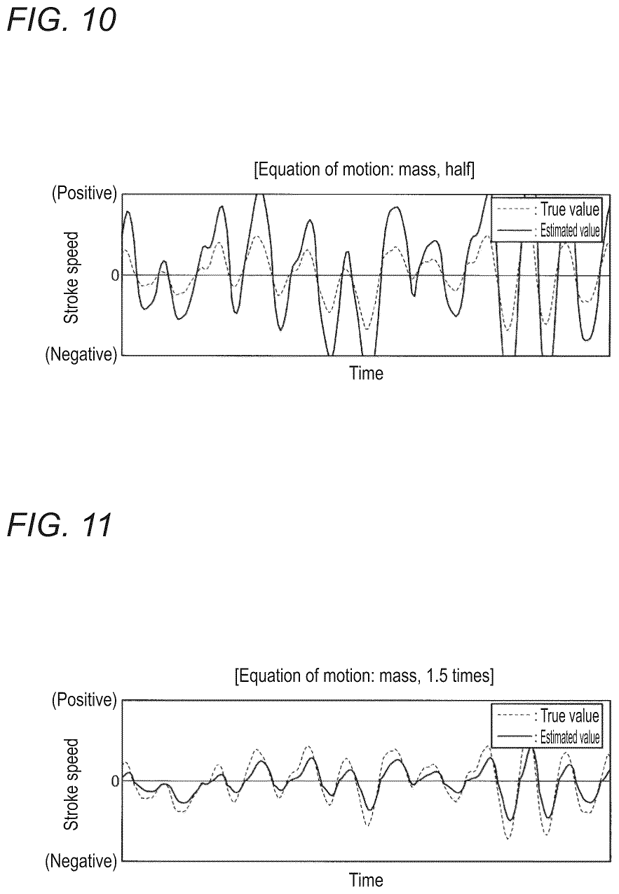

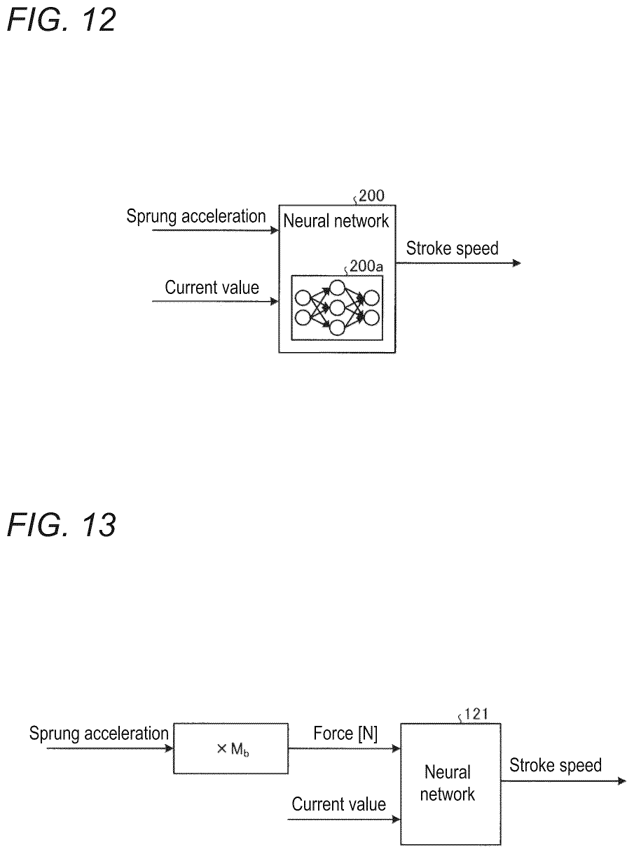

The inventor has calculated the estimated value of the stroke speed by the neural network 200 and expression (2) while changing the mass. The results are illustrated in FIGS. 6 to 11. FIG. 6 is a diagram illustrating an example of the estimation result of the stroke speed by the neural network 121 to be examined, and is a diagram illustrating a case where the mass of the vehicle 1 is a reference mass. FIG. 7 is a diagram illustrating an example of the estimation result of the stroke speed by the neural network 121 to be examined, and is a diagram illustrating a case where the mass of the vehicle 1 is half of the reference. FIG. 8 is a diagram illustrating an example of the estimation result of the stroke speed by the neural network 121 to be examined, and is a diagram illustrating a case where the mass of the vehicle 1 is 1.5 times the reference. FIG. 9 is a diagram illustrating an example of the estimation result of the stroke speed by the equation of motion to be examined, and is a diagram illustrating a case where the mass of the vehicle 1 is a reference mass. FIG. 10 is a diagram illustrating an example of the estimation result of the stroke speed by the equation of motion to be examined, and is a diagram illustrating a case where the mass of the vehicle 1 is half of the reference. FIG. 11 is a diagram illustrating an example of the estimation result of the stroke speed by the equation of motion to be examined, and is a diagram illustrating a case where the mass of the vehicle 1 is 1.5 times the reference.

As illustrated in FIGS. 6 and 9, in a case where the mass to be input is a reference mass, the result that the estimated value is close to the true value is obtained in both the neural network 200 and equation (2). As illustrated in FIGS. 7 and 10, in a case where the mass to be input is half of the reference mass, the result that the deviation of the estimated value from the true value is large is obtained in both the neural network 200 and equation (2). As illustrated in FIGS. 8 and 11, in a case where the mass to be input is 1.5 times the reference, the result that the deviation of the estimated value from the true value is large is obtained in both the neural network 200 and equation (2). That is, when different numerical values are intentionally input as the input value, the deviation of the estimated value from the true value increases. This deviation can be regarded as a mistake.

From the results, the inventor has found that the deviation of the estimated value from the true value, that is, the way of mistaking the estimated value in a case where different numerical values are intentionally input as the input value is similar between the neural network 200 and expression (2). Then, as illustrated in FIG. 12, the inventor has considered that a portion 200a corresponding to a parameter called mass is present in the neural network 200, and have conceived that the parameter called mass can be located outside of the neural network 200. In addition, the inventor has conceived a configuration in which the parameter called mass is located outside of the neural network 121 of the present embodiment.

Hereinafter, the neural network 121 will be described. FIG. 13 is a diagram illustrating the neural network 121 according to the first embodiment. The neural network 121 is configured to perform learning in advance so as to estimate the relative speed of the wheel 3 of the vehicle 1 with respect to the vehicle body 2 of the vehicle 1 in the vertical direction of the vehicle 1, that is, the stroke speed based on the input of the input data. For example, the neural network 121 includes a long short-term memory (LSTM). At the time of learning of the neural network 121, the input data is the numerical value of force obtained by multiplying the sprung acceleration by the mass, and the current value of the shock absorber 4b. The sprung acceleration is the acceleration detected by the acceleration sensor 6, that is, the acceleration of the vehicle body 2 in the vertical direction of the vehicle 1. The mass is a reference mass. That is, the mass is a constant. The output data as teacher data is, for example, the actual measurement value (true value) of the relative speed of the wheel 3 of the vehicle 1 with respect to the vehicle body 2 of the vehicle 1, that is, the stroke speed measured by a stroke speed sensor (not illustrated) The sprung acceleration is an example of a first physical quantity, the mass is an example of a second physical quantity, and the stroke speed is an example of a third physical quantity.

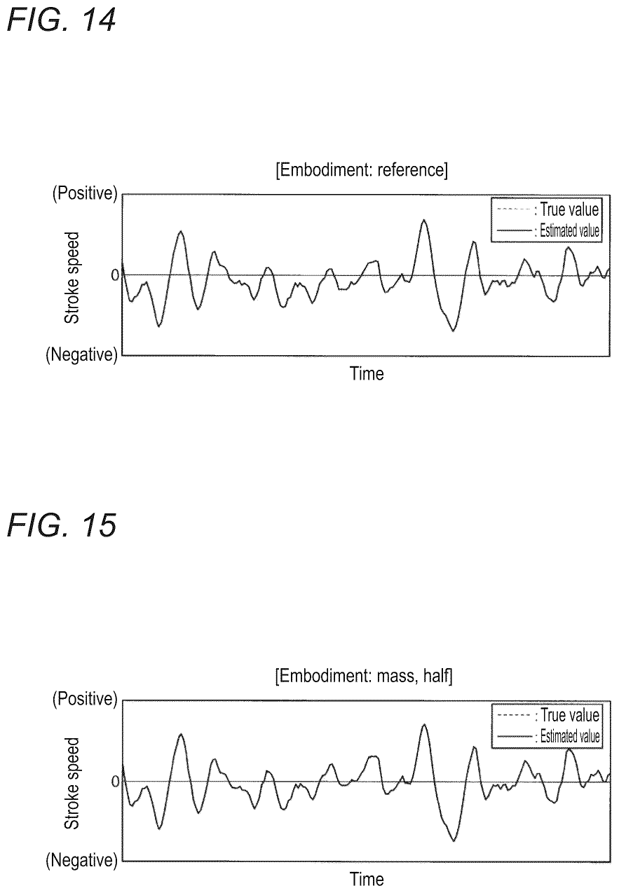

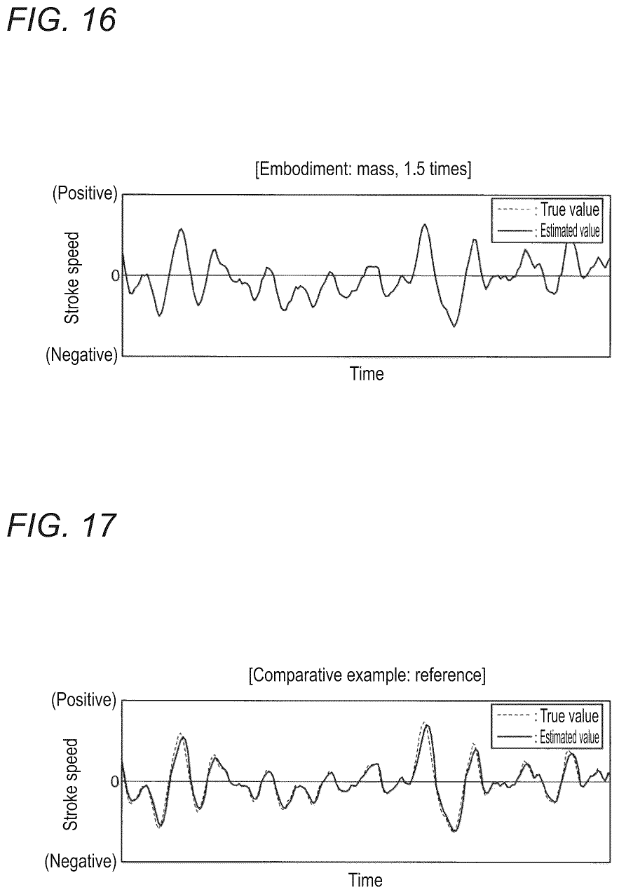

FIG. 14 is a diagram illustrating an example of the estimation result of the stroke speed by the neural network 121 according to the first embodiment, and is a diagram illustrating a case where the mass of the vehicle 1 is a reference mass. FIG. 15 is a diagram illustrating an example of the estimation result of the stroke speed by the neural network 121 according to the first embodiment, and is a diagram illustrating a case where the mass of the vehicle 1 is half of the reference. FIG. 16 is a diagram illustrating an example of the estimation result of the stroke speed by the neural network 121 according to the first embodiment, and is a diagram illustrating a case where the mass of the vehicle 1 is 1.5 times the reference.

As illustrated in FIGS. 14 to 16, a result can be obtained in which even when the mass used for calculating the input data is changed in the neural network 121, the estimated value substantially matches the true value.

Here, even if the mass outside the neural network 121 is not multiplied by the sprung acceleration and is alone input to the neural network 121 as the input data, the neural network 121 has not learned the mass as a parameter and thus does not recognize the mass. For this reason, even if the mass is changed and input to the neural network 121, the deviation of the estimated value from the true value increases. On the other hand, in the present embodiment, since the mass is multiplied by the sprung acceleration, the multiplied value of the mass and the sprung acceleration is recognized by the neural network 121 as a parameter. As a result, even if the mass is changed, it is possible to prevent the deviation of the estimated value from the true value from increasing. Therefore, the neural network 121 with the same content can be used for a plurality of vehicles 1 with different masses. That is, the neural network 121 created for one vehicle 1 among the vehicles 1 having a plurality of specifications can be used for another vehicle 1 having a different specification. In such a neural network 121, the mass (second physical quantity) of the vehicle 1 may be the same as or different from that at the time of learning of the neural network 121. For example, in a case where the neural network 121 is created for the gasoline/two-wheel drive vehicle 1, the mass of the vehicle 1 used for the neural network 121 is the same as that at the time of learning in the neural network 121 provided in the gasoline/two-wheel drive vehicle 1. On the other hand, in the neural network 121 provided in the vehicle 1 of another specification (hybrid/two-wheel drive specification, gasoline/four-wheel drive specification, and hybrid/four-wheel drive specification), the mass of the vehicle 1 used for the neural network 121 is different from that at the time of learning.

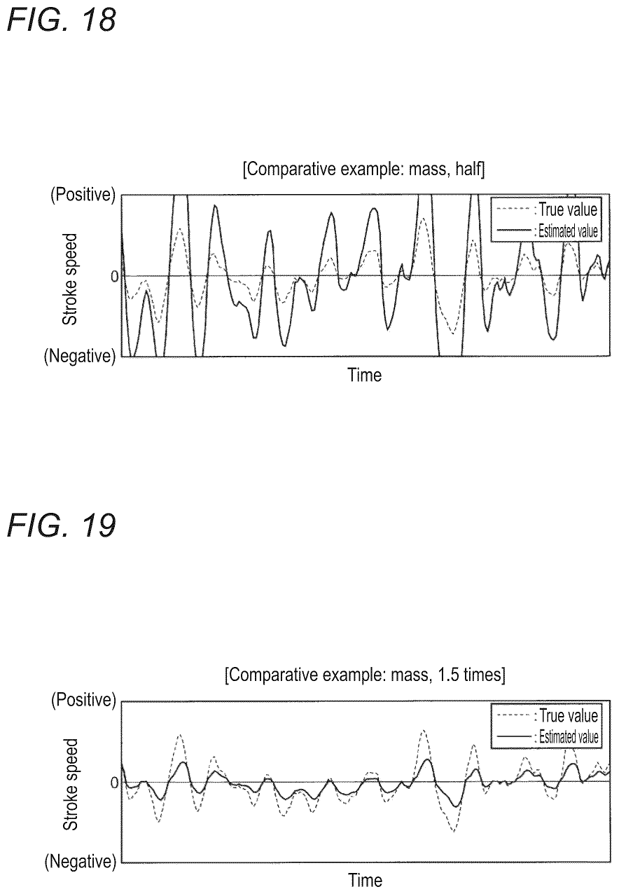

Here, the waveforms illustrated in FIGS. 14 to 16 are different from the waveforms illustrated in FIGS. 6 to 8 because the specifications of the vehicle 1 used for the simulation are different. The waveforms of the stroke speed based on the equation of motion (comparative example) created by the specifications of the vehicle 1 with the waveforms illustrated in FIGS. 14 to 16 are illustrated in FIGS. 17 to 19.

Returning to FIG. 3, the damping control unit 10c controls the damping force of the shock absorber 4b on the basis of the stroke speed estimated by the estimation unit 10b. Specifically, the damping control unit 10c determines a current value to be input to the shock absorber 4b, and inputs the current value to the shock absorber 4b.

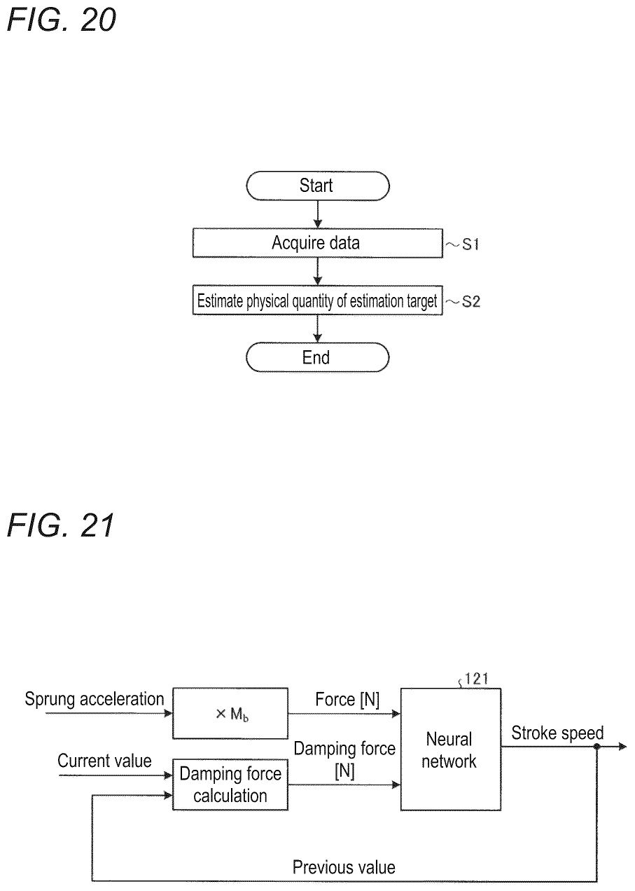

Next, an example of the physical quantity estimation direction performed by the control device 10 will be described with reference to FIG. 20. FIG. 20 is a flowchart illustrating an example of the physical quantity estimation direction performed by the control device 10 according to the first embodiment.

As illustrated in FIG. 20, first, the acquisition unit 10a acquires input data (data) (S1). The input data includes, for example, a sprung acceleration and a current value of the shock absorber 4b. Next, the estimation unit 10b inputs the numerical value obtained by multiplying the sprung acceleration from the acquisition unit 10a by the mass of the vehicle 1, and the current value acquired by the acquisition unit 10a to the neural network 121, and estimates the physical quantity, which is an estimation target, by the neural network 121 (S2). The physical quantity is, for example, a stroke speed. The mass is stored in the storage unit 10d. That is, the storage unit 10d stores the second physical quantity input to the neural network 121.

As described above, in the present embodiment, the control device 10 includes the acquisition unit 10a and the estimation unit 10b. The acquisition unit 10a acquires the first physical quantity that is a variable related to the vehicle 1 (object). The estimation unit 10b uses the neural network 121 that has performed learning so as to estimate the third physical quantity related to the vehicle 1 based on the input of the numerical value obtained by multiplying the first physical quantity by the second physical quantity related to the vehicle 1 to estimate the third physical quantity corresponding to the numerical value obtained by multiplying the first physical quantity acquired by the acquisition unit 10a by the second physical quantity with the same magnitude as or different magnitude from that at the time of learning of the neural network 121. The first to third physical quantities are, for example, physical quantities related to the motion of the vehicle 1.

According to such a configuration, for example, the neural network 121 with the same content can be used for the vehicle 1 having a plurality of specifications with different second physical quantities. Therefore, even in a case where there are a plurality of specifications for the vehicle 1, it is possible to reduce the time and effort required for creating the neural network 121.

In addition, the first physical quantity is the acceleration of the vehicle body 2 in the vertical direction of the vehicle 1, and the second physical quantity is the mass of the vehicle 1. The third physical quantity is the relative speed (stroke speed) of the wheel 3 with respect to the vehicle body 2 in the vertical direction of the vehicle 1.

According to such a configuration, even in a case where there are a plurality of specifications with different masses for the vehicle 1, it is possible to reduce the time and effort required for creating the neural network 121.

### Second Embodiment

FIG. 21 is a diagram illustrating a neural network 121 according to a second embodiment.

As illustrated in FIG. 21, the present embodiment is mainly different from the first embodiment in that the input data input to the neural network 121 is a numerical value of force obtained by multiplying a sprung acceleration by the mass of the vehicle 1 and the damping force of the shock absorber 4b.

The damping force of the shock absorber 4b is calculated on the basis of a current value of the shock absorber 4b and the stroke speed previously estimated by the estimation unit 10b in estimation of the stroke speed (third physical quantity) by the estimation unit 10b. Specifically, the damping force is calculated on the basis of the damping coefficient of the shock absorber based on the current value of the shock absorber 4b and the stroke speed previously estimated by the estimation unit 10b. The estimation unit 10b multiplies the damping coefficient of the shock absorber 4b or a quantity related to the damping coefficient by the stroke speed (relative speed) previously estimated to estimate a new stroke speed (relative speed). The stroke speed (third physical quantity) previously estimated by the estimation unit 10b corresponds to the first physical quantity in the current estimation of the stroke speed by the estimation unit 10b. In addition, the current value of the shock absorber 4b is an example of the second physical quantity.

As described above, in the present embodiment, the estimation unit 10b uses the third physical quantity previously estimated as the first physical quantity in the estimation of the third physical quantity.

According to such a configuration, the estimation unit 10b can estimate the latest third physical quantity using the third physical quantity previously estimated by the estimation unit 10b.

In addition, the second physical quantity is a quantity (current value) related to the damping coefficient of the shock absorber 4b. The third physical quantity is the relative speed of the wheel 3 with respect to the vehicle body 2 in the vertical direction of the vehicle 1, that is, the stroke speed.

According to such a configuration, even in a case where there are a plurality of specifications with different quantities related to the damping coefficient of the shock absorber 4b for the vehicle 1, it is possible to reduce the time and effort required for creating the neural network 121.

Note that, instead of the current value that is the quantity related to the damping coefficient of the shock absorber 4b, the damping coefficient of the shock absorber 4b may be used.

### Third Embodiment

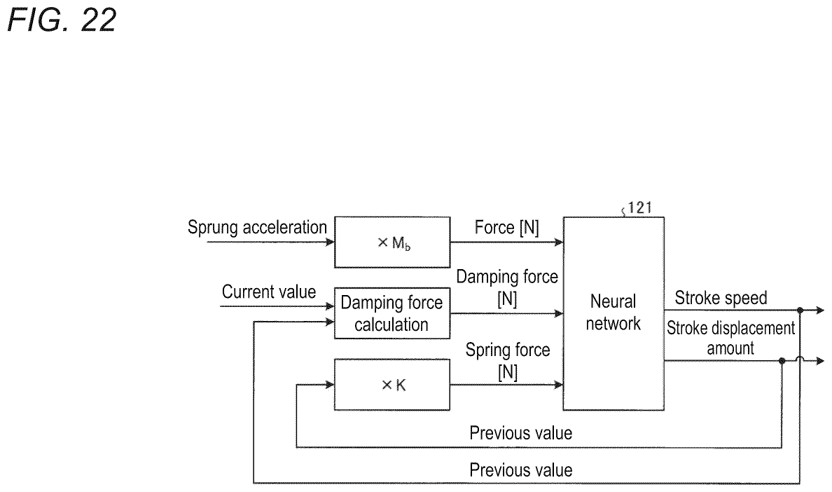

FIG. 22 is a diagram illustrating a neural network 121 according to a third embodiment.

As illustrated in FIG. 22, the present embodiment is mainly different from the second embodiment in that the input data input to the neural network 121 is a numerical value of force obtained by multiplying a sprung acceleration by the mass of the vehicle 1, the damping force of the shock absorber 4b, and the spring force of the coil spring 4a. Furthermore, in the present embodiment, the output data is a stroke speed and a relative displacement amount (so-called stroke displacement amount) of the wheel 3 with respect to the vehicle body 2 in the vertical direction of the vehicle 1.

The spring force of the coil spring 4a is calculated on the basis of the spring constant of the coil spring 4a and the stroke displacement amount previously estimated by the estimation unit 10b. Specifically, the spring force of the coil spring 4a is calculated by multiplying the spring constant of the coil spring 4a by the stroke displacement amount previously estimated by the estimation unit 10b. The estimation unit 10b multiplies the spring constant of the coil spring 4a by the stroke displacement amount previously estimated to estimate a new stroke displacement amount. The stroke displacement amount (third physical quantity) previously estimated by the estimation unit 10b corresponds to the first physical quantity in the current estimation of the stroke displacement amount by the estimation unit 10b. Furthermore, the spring constant of the coil spring 4a is an example of the second physical quantity.

As described above, in the present embodiment, the second physical quantity is the spring constant of the coil spring 4a (spring). The third physical quantity is the stroke displacement amount that is the relative displacement amount of the wheel 3 with respect to the vehicle body 2 in the vertical direction of the vehicle 1.

According to such a configuration, even in a case where there are a plurality of specifications with different spring constants of the coil spring 4a for the vehicle 1, it is possible to reduce the time and effort required for creating the neural network 121.

### Fourth Embodiment

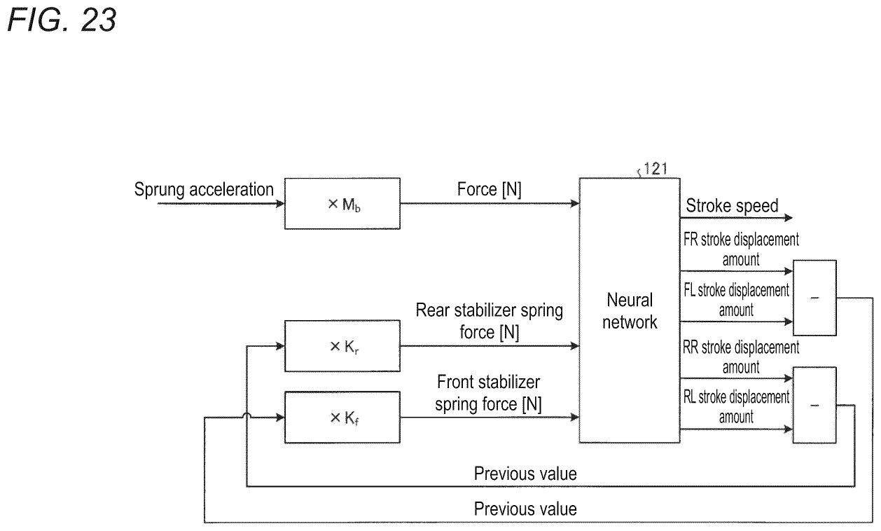

FIG. 23 is a diagram illustrating a neural network 121 according to a fourth embodiment.

In the present embodiment, the vehicle 1 includes a front stabilizer (not illustrated) and a rear stabilizer (not illustrated). In addition, as illustrated in FIG. 23, the present embodiment is mainly different from the second embodiment in that the input data input to the neural network 121 is a numerical value of force obtained by multiplying a sprung acceleration by the mass of the vehicle 1, a front stabilizer spring force, and a rear stabilizer spring force. Furthermore, in the present embodiment, the output data (third physical quantity) includes a stroke speed, an FR stroke displacement amount, which is a stroke displacement amount of the right front portion of the vehicle 1, an FL stroke displacement amount, which is a stroke displacement amount of the left front portion of the vehicle 1, an RR stroke displacement amount, which is a stroke displacement amount of the right rear portion of the vehicle 1, and an RL stroke displacement amount, which is a stroke displacement amount of the right front portion of the vehicle 1.

The front stabilizer spring force is calculated by multiplying the difference value between the FR stroke displacement amount and the FL stroke displacement amount, which are previously estimated by the estimation unit 10b, by a spring constant (Kf) of the front stabilizer. The rear stabilizer spring force is calculated by multiplying the difference value between the RR stroke displacement amount and the RL stroke displacement amount, which are previously estimated by the estimation unit 10b, by a spring constant (Kr) of the rear stabilizer. The FL stroke displacement amount, the FR stroke displacement amount, the RR stroke displacement amount, and the RR stroke displacement amount (third physical quantities) previously estimated by the estimation unit 10b correspond to the second physical quantity in the current estimation of the stroke displacement amount by the estimation unit 10b. The spring constant of the front stabilizer and the spring constant of the rear stabilizer are the second physical quantities.

As described above, in the present embodiment, the second physical quantity includes the spring constant of the front stabilizer and the spring constant of the rear stabilizer.

According to such a configuration, even in a case where there are a plurality of specifications with different spring constants of the front stabilizer and the rear stabilizer for the vehicle 1, it is possible to reduce the time and effort required for creating the neural network 121.

Note that, in the embodiments, the first physical quantity may be acceleration in the front-rear direction of the vehicle body 2, acceleration in the left-right direction (lateral direction) of the vehicle body 2, the speed of the wheel, the yaw rate of the vehicle body 2, or the like. In addition, the second physical quantity may be the height of the center of gravity of the vehicle 1. A pitch moment is calculated by multiplying the acceleration of the vehicle body 2 in the front-rear direction by the height of the center of gravity of the vehicle 1, and this pitch moment may be used as input data of the neural network 121. Furthermore, a roll moment is calculated by multiplying the acceleration of the vehicle body 2 in the left-right direction by the height of the center of gravity of the vehicle 1, and this roll moment may be used as input data of the neural network 121.

Moreover, in the embodiments, the mass of the vehicle 1 that is the second physical quantity may be a value including an occupant and a load of the vehicle 1. In this case, by providing a detection device that detects the mass of the occupant and the load of the vehicle 1, the mass of the vehicle 1 including the occupant and the load can be calculated.

Although the embodiments have been described in the present disclosure, these are presented as examples, and are not intended to limit the scope of the disclosure. These novel embodiments can be implemented in various other forms, and various omissions, substitutions, and changes can be made without departing from the gist of the disclosure. These embodiments and modifications thereof are included in the scope and gist of the disclosure, and are included in various aspects described in the claims and the equivalent scope thereof.

### SUMMARY OF PRESENT EMBODIMENT

The control device (10) of the present embodiment has at least the following configuration.

That is, the control device (10) is a control device (10) that controls a suspension device (4) interposed between a vehicle body (2) of a vehicle (1) and a wheel (3) of the vehicle (1), and includes
an acquisition unit (10a) that acquires acceleration of the vehicle body (2) in a vertical direction of the vehicle (1), and
an estimation unit (10b) that uses a neural network (121) that has performed learning so as to estimate a relative speed of the wheel (3) with respect to the vehicle body (2) in the vertical direction of the vehicle (1) based on an input of a numerical value obtained by multiplying the acceleration by a mass of the vehicle (1) to estimate a relative speed corresponding to a numerical value obtained by multiplying the acceleration acquired by the acquisition unit (10a) by the mass with a same magnitude as or a different magnitude from that at the time of learning of the neural network (121), and
the suspension device (4) is controlled on the basis of the relative speed estimated.

According to the configuration, for example, the neural network (121) with the same content can be used for the vehicle (1) having a plurality of specifications with different masses. Therefore, even in a case where there are a plurality of specifications for the vehicle (1), it is possible to reduce the time and effort required for creating the neural network (121).

In addition, preferably, the control device (10) of the embodiment includes a shock absorber (4b) interposed between the vehicle body (2) and the wheel (3), and the estimation unit (10b) estimates a new relative speed by multiplying the damping coefficient of the shock absorber (4b) or a quantity related to the damping coefficient by the relative speed previously estimated.

According to the configuration, even in a case where there are a plurality of specifications with different damping coefficients of the shock absorber (4b) or different quantities related to the damping coefficient for the vehicle (1), it is possible to reduce the time and effort required for creating the neural network (121).

Furthermore, preferably, the control device (10) of the embodiment includes a spring (4a) interposed between the vehicle body (2) and the wheel (3), the relative displacement amount of the wheel (3) with respect to the vehicle body (2) in the vertical direction of the vehicle is estimated from the relative speed, and the estimation unit (10b) estimates a new relative displacement amount by multiplying the spring constant of the spring (4a) by the relative displacement amount previously estimated. According to the configuration, even in a case where there are a plurality of specifications with different spring constants of the spring (4a) for the vehicle (1), it is possible to reduce the time and effort required for creating the neural network (121).

### REFERENCE SIGNS LIST

1: Vehicle, 2: Vehicle body, 3: Wheel, 4: Suspension device, 4a: Coil spring (Spring), 4b: Shock absorber, 10: Control device, 10a: Acquisition unit, 10b: Estimation unit, and 121: Neural network

1. A control device that controls a suspension device interposed between a vehicle body of a vehicle and a wheel of the vehicle, the control device comprising:
an acquisition unit that acquires acceleration of the vehicle body in a vertical direction of the vehicle; and
an estimation unit that uses a neural network that has performed learning so as to estimate a relative speed of the wheel with respect to the vehicle body in the vertical direction of the vehicle based on an input of a numerical value obtained by multiplying the acceleration by a mass of the vehicle to estimate the relative speed corresponding to a numerical value obtained by multiplying the acceleration acquired by the acquisition unit by the mass with a same magnitude as or a different magnitude from a mass at a time of learning of the neural network, wherein
the suspension device is controlled based on the relative speed estimated.

2. The control device according to claim 1, further comprising a shock absorber interposed between the vehicle body and the wheel, wherein
the estimation unit estimates the relative speed that is new by multiplying a damping coefficient of the shock absorber or a quantity related to the damping coefficient by the relative speed previously estimated.

3. The control device according to claim 1, further comprising a spring interposed between the vehicle body and the wheel, wherein
a relative displacement amount of the wheel with respect to the vehicle body in the vertical direction of the vehicle is estimated from the relative speed, and
the estimation unit estimates the relative displacement amount, which is new, by multiplying a spring constant of the spring by the relative displacement amount previously estimated.
